(19) United States
(12) Patent Application Publication
(10) Pub. No.: US 2025/0096637 A1
(43) Pub. Date: Mar. 20, 2025

(54) MOTOR AND ELECTRICAL PRODUCT

(71) Applicant: NIDEC CORPORATION, Kyoto (JP)

(72) Inventor: Zhipeng LI, Dalian (CN)

(21) Appl. No.: 18/783,736

(22) Filed: Jul. 25, 2024

(30) Foreign Application Priority Data
Sep. 20, 2023 (CN) 202311220834.9

(51) Int. Cl. H02K 5/22

(52) U.S. Cl. CPC H02K 5/22; H02K 2203/09

(57) ABSTRACT

A motor includes a main body portion, including a rotor and a stator, a case including a bottom and an opening, and accommodating the main body portion, a busbar assembly, which is located on an axially upper side of the main body portion, and a cover portion, which is located on an axially upper side of the busbar assembly and covers the opening of the case. An upper surface of the busbar assembly is provided with a groove. A first through hole opposite to the groove in an axial direction is defined in the cover portion, and the motor is connected to an external device through the groove and the first through hole. The motor is connected to the external device through the groove and the first through hole, so that a portion of the external device can be accommodated in the busbar assembly.

### CROSS-REFERENCE TO RELATED APPLICATIONS

The present application claims priority under 35 U.S.C. § 119 to Chinese Patent Application No. 202311220834.9, filed on Sep. 20, 2023, the entire contents of which are hereby incorporated herein by reference.

### 1. FIELD OF THE INVENTION

The present application relates to the electromechanical field, in particular, to motors and electrical products.

### 2. BACKGROUND

In the existing motor structure, in order to connect or fix a motor to an external device, a component for connection or fixation with the external device needs to be disposed on a cover portion of the motor, which requires the motor to have a certain height in an axial direction, thereby affecting a miniaturization design of the motor.

It should be noted that the above introduction to the technical background is only for the convenience of a clear and complete description of the technical solutions of the present application, and for the convenience of understanding by those skilled in the art. It cannot be considered that the above technical solutions are known to those skilled in the art just because these solutions are described in the background section of the present application.

### SUMMARY

The inventors have discovered that in the existing motor structure, when the external device is connected to the motor, it occupies an axial dimension of the motor, resulting in a large axial dimension of the motor.

According to a first example embodiment of the present application, a motor includes a main body portion, including a rotor and a stator, a case, which is in an axially extending cylindrical shape, includes a bottom and an opening, and accommodates the main body portion, a busbar assembly, which is located on an axially upper side of the main body portion, and a cover portion, which is located on an axially upper side of the busbar assembly and covers the opening of the case. An upper surface of the busbar assembly is provided with a groove. A first through hole axially opposite to the groove is provided in the cover portion. The motor is connected to an external device through the groove and the first through hole.

In one or more example embodiments, an internal thread to provide threaded connection with the external device is defined in an inner surface of the first through hole.

In one or more example embodiments, a coupling portion is located in the first through hole and the motor is connected to the external device through the groove, the first through hole, and the coupling portion.

In one or more example embodiments, the connecting portion also includes a coupling portion located inside the first through hole, the coupling portion includes a small diameter portion and a large diameter portion, the small diameter portion extends out of the first through hole and is located on an axially upper side of the cover portion, and the large diameter portion is located on an axially lower side of the cover portion.

In one or more example embodiments, the coupling portion is provided with a second through hole that penetrates in the axial direction and is axially opposed to the groove, and an internal thread to provide threaded connection with the external device is defined in an inner surface of the second through hole.

In one or more example embodiments, the upper surface of the busbar assembly is further provided with a recessed portion, the groove is located in the recessed portion, and the large diameter portion of the coupling portion is at least partially located in the recessed portion.

In one or more example embodiments, a diameter of an inscribed circle of the groove is greater than or equal to an inner diameter of the coupling portion.

In one or more example embodiments, the busbar assembly includes a busbar holder and a busbar embedded in the busbar holder, and the busbar is staggered from the groove in the axial direction.

According to further example embodiments of the present application, an electrical product is provided. The electrical product includes the motor according to the above example embodiments.

The example embodiments and implementations of the present application will be disclosed in detail with reference to the following description and accompanying drawings. It should be understood that the example embodiments and implementations of the present application are not limited thereby in scope. The example embodiments and implementations of the present application encompass many changes, modifications and equivalents within the scope of the spirit and terms of the appended claims.

Features described and/or illustrated with respect to one example embodiment or implementation may be used in the same or similar manner in one or more other implementations, in combination with, or instead of features in other implementations.

The above and other elements, features, steps, characteristics and advantages of the present disclosure will become more apparent from the following detailed description of the example embodiments with reference to the attached drawings.

### BRIEF DESCRIPTION OF THE DRAWINGS

The included accompanying drawings are used to provide a further understanding of the example embodiments of the present application, which constitute a part of the description to illustrate the implementations of the present application, and explain the principle of the present application together with the text description. Apparently, the accompanying drawings in the following description are only some example embodiments of the present application, and those of ordinary skill in the art can also obtain other accompanying drawings according to these drawings without paying creative work. In the accompanying drawings:

FIG. 1 is a schematic diagram of a motor according to an example embodiment of the present application.

FIG. 2 is sectional view of the motor shown in FIG. 1;

FIG. 3 is a schematic diagram of the motor shown in FIG. 1 from which a cover portion is removed.

FIG. 4 is a schematic diagram of the cover portion of the motor shown in FIG. 1.

FIG. 5 is a schematic diagram of a coupling portion according to an example embodiment of the present application.

FIG. 6 is a sectional view of the coupling portion according to an example embodiment of the present application.

FIG. 7 is a schematic diagram of part of the motor from which the cover portion is removed according to an example embodiment of the present application.

### DETAILED DESCRIPTION

The foregoing and other features of the present application will become apparent from the following description with reference to the accompanying drawings. In the description and accompanying drawings, specific implementations of the present application are disclosed, which indicate some implementations in which the principles of the present application can be adopted. It should be understood that the present application is not limited to the described implementations. On the contrary, the present application includes all modifications, variations and equivalents that fall within the scope of the appended claims.

In the example embodiments of the present application, the term “and/or” includes any one and all combinations of one or more of the associated listed terms. The terms “comprising”, “including”, “having” and the like refer to the presence of stated features, elements, component or assemblies, but do not exclude the presence or addition of one or more other features, elements, components or assemblies.

In the example embodiments of the present application, the singular forms “a”, “this” and the like may include plural forms, which should be broadly understood as “a kind” or “a class”, but not limited to the meaning of “one”. In addition, the term “the” should be understood to include both the singular form and the plural form, unless the context clearly dictates otherwise. Furthermore, the term “according to” should be understood as “at least in part according to . . . ”; and the term “based on” should be understood as “at least in part based on . . . ”, unless the context clearly indicates otherwise.

In addition, in the following description of the present application, for the convenience of description, a direction extending along a central axis OO′ of a motor or a direction parallel to this direction is referred to as an “axial direction”; a radius direction centered on the central axis OO′ is referred to as a “radial direction”; a direction around the central axis OO′ is referred to as a “circumferential direction”; a side away from the central axis OO′ in the radius direction is referred to as a “radially outer side”; a side close to the central axis OO′ in the radius direction is referred to as a “radially inner side”; a direction of the bottom of a motor casing pointing to an opening is referred to as an “axial side” or “axially upper side” or “upper side” or “above”; and a direction of the opening of the motor casing pointing to the bottom is referred to as “the other axial side”, “axially lower side”, “lower side” or “below”. However, it is worth noting that these are for illustrative convenience only and do not limit the orientation of the motor when used and manufactured.

Various implementations of the example embodiments of the present application will be described below with reference to the accompanying drawings.

This example embodiment of the present application provides a motor.

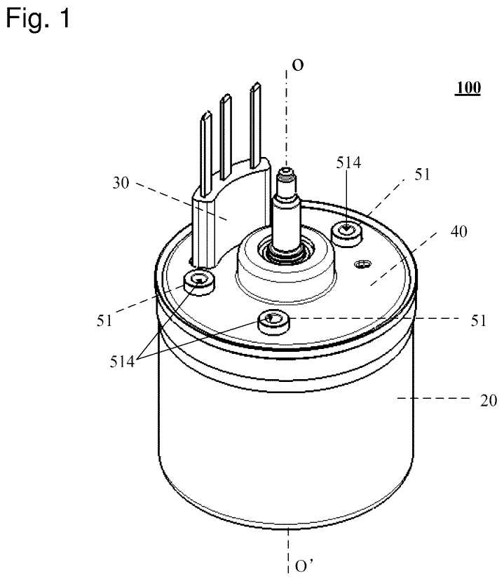

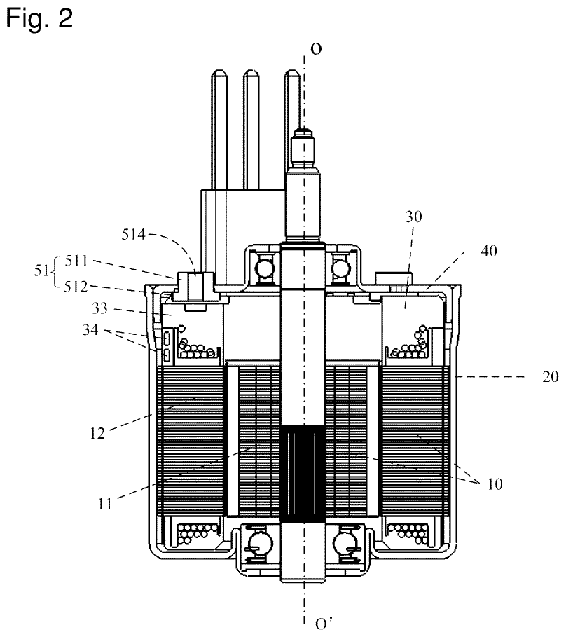

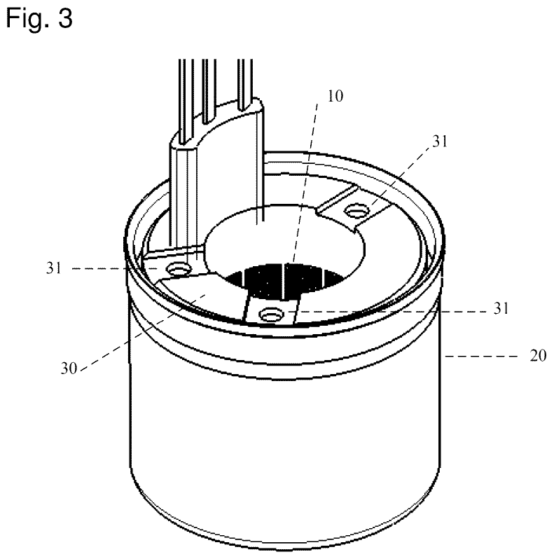

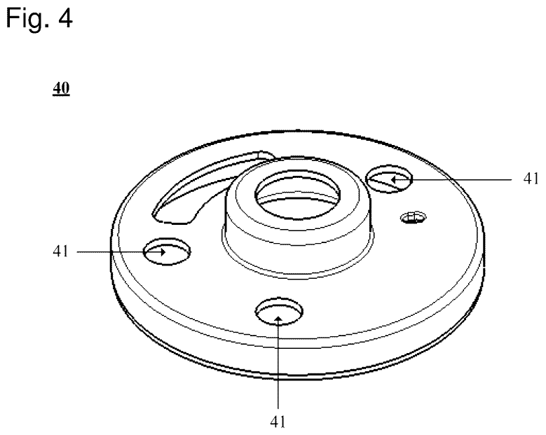

FIG. 1 is a schematic diagram of a motor according to an example embodiment of the present application. FIG. 2 is sectional view of the motor shown in FIG. 1. FIG. 3 is a schematic diagram of the motor shown in FIG. 1 from which a cover portion is removed. FIG. 4 is a schematic diagram of the cover portion of the motor shown in FIG. 1.

As shown in FIGS. 1 to 3, in the example embodiments of the present application, the motor 100 includes: a main body portion 10 (not shown in FIG. 1), a case 20 that accommodates the main body portion 10, a busbar assembly 30 located on an axially upper side of the main body portion 10, and a cover portion 40 (not shown in FIG. 3) covering an opening of a motor enclosure.

as shown in FIG. 2, the main body portion 10 includes a rotor 11 and a stator 12. The rotor 11 may include a rotating shaft, a rotor core, a plurality of rotor magnets, etc. The stator 12 may include a stator core, a coil, an insulating member, etc., and details may refer to related technologies. In addition, the main body portion 10 may also include a bearing or other components, and details may refer to the related technologies.

As shown in FIGS. 1 to 3, the case 20 is in an axially extending cylindrical shape and has a bottom and an opening. The case 20 surrounds the main body portion 10 and is located on a radial outer side of the main body portion 10.

As shown in FIGS. 1 and 2, the cover portion 40 covers an opening of the case 20.

In the example embodiments of the present application, as shown in FIG. 3, an upper surface of the busbar assembly 30 is provided with a groove 31, a first through hole 41 axially opposite to the groove 31 is formed in the cover portion 40, and the motor 100 is connected to an external device via the groove 31 and the first through hole 41.

According to the above example embodiments, by forming the through hole in the cover portion of the motor and the groove axially opposite to the through hole in the upper surface of the busbar assembly, the motor is connected to the external device through the groove and the through hole, so a part of the external device is accommodated in the busbar assembly, thereby reducing an axial dimension of the motor and miniaturizing the motor.

In the example of FIG. 3, the circular groove 31 is taken as an example, but the present application is not limited thereto. The groove 31 may also be in other shapes, such as a polygonal or irregular shape, as long as it is recessed axially downwards relative to the upper surface of the busbar assembly 30. In addition, in the example of FIG. 3, three grooves 31 are shown. The number of the grooves 31 will not be limited in the present application. Since the grooves 31 are used to connect the motor to the external device, their number, position and shape depend on the requirements of the external device.

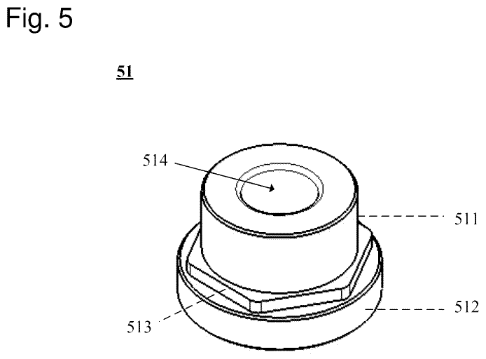

In the above example embodiments, the first through holes 41 are axially opposite to the grooves 31, and the number and positions of the first through holes 41 correspond to those of the grooves 31. A method for forming the first through hole 41 will not be limited in the present application. For example, as shown in FIG. 4, the cover portion 40 may be formed first, and then the first through hole 41 that penetrates through the cover portion 40 in the axial direction may be formed in the cover portion 40 by means of stamping, etc.; or, the cover portion 40 may be formed by means of mold casting, etc., the cover portion 40 has a radially extending portion and an axially extending portion, the axially extending portion is provided with the first through hole 41 that is penetrated in the axial direction, and the axially extending portion has, for example, a structure shown in FIG. 5 below, which will be described in detail later. In addition, a shape of a cross section of the first through hole 41 depends on connection requirements of the external device, and may be a circle as shown in FIG. 4, or may be other shapes.

In the above example embodiments, the motor 100 is connected to the external device through the groove 31 and the first through hole 41, and the connection methods include but are not limited to threaded connection, riveting, glue injection, press-fit connection, snap-fit connection, etc. Examples are given below to illustrate.

In one or more example embodiments, an internal thread to provide threaded connection with the external device is formed in the inner surface of the first through hole 41. Therefore, the motor 100 is in threaded connection to the external device only through the groove 31 and the first through hole 41.

For example, the external device is screwed into the first through hole 41 through a bolt having an external thread, and extends into the groove 31 of the busbar assembly 30 inside the motor 100, thereby achieving the threaded connection.

Furthermore, in the case where the first through hole 41 is formed in the axially extending portion in the above example, a connection length for connection with the external device is increased, thereby further improving the connection strength and stability.

In other example embodiments, as shown in FIG. 1 and FIG. 2, a coupling portion 51 is disposed in the first through hole 41, so that the motor 100 is connected to the external device through the groove 31, the first through hole 41 and the coupling portion 51. For example, in the case where the first through hole 41 is formed by punching the cover portion 40, by disposing the coupling portion 51 in the first through hole 41, a connection length for connection with the external device is enhanced.

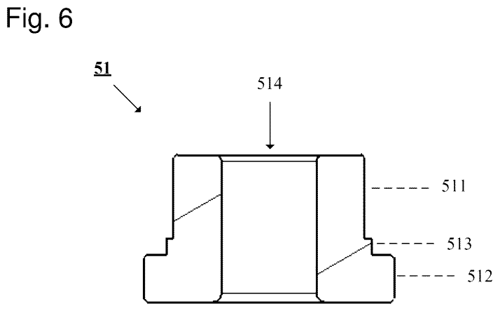

FIG. 5 is a schematic diagram of the coupling portion 51 according to an example embodiment of the present application. FIG. 6 is a sectional view of the coupling portion 51 according to an example embodiment of the present application.

In some example embodiments, as shown in FIG. 5 and FIG. 6, the coupling portion 51 has a small diameter portion 511 and a large diameter portion 512. As shown in FIG. 2, the small diameter portion 511 passes out of the first through hole 41 and is located on an axially upper side of the cover portion 40, and the large diameter portion 512 is located on an axially lower side of the cover portion 40. Therefore, the connection length between the motor and the external device can be increased without increasing the axial dimension of the motor, thereby further improving the strength and stability of the connection.

In the above example embodiments, as shown in FIG. 5, the small diameter portion 511 and the large diameter portion 512 are each cylindrical. Wherein, an outer diameter of the small diameter portion 511 is less than or equal to an inner diameter of the first through hole 41, and an outer diameter of the large diameter portion 512 is larger than the inner diameter of the first through hole 41. Therefore, the small diameter portion 511 can easily pass through the first through hole 41, while preventing the large diameter portion 512 from passing out of the first through hole 41.

In some example embodiments, as shown in FIG. 6, the small diameter portion 511 and the large diameter portion 512 have the same inner diameter. Since the small diameter portion 511 and the large diameter portion 512 are both cylindrical, they are both provided with through holes. The through hole of the small diameter portion 511 and the through hole of the large diameter portion 512 together constitute the second through hole 514 of the coupling portion 51. That is, the coupling portion 51 is provided with the second through hole 514 that is penetrated in the axial direction and is axially opposite to the groove 31; and an internal thread to provide threaded connection with the external device is formed in an inner surface of the second through hole 514. Therefore, the external device may be screwed into the second through hole 514 through a bolt having an external thread, and extends into the groove 31 of the busbar assembly 30 inside the motor 100, thereby achieving the threaded connection.

In the above example embodiments, the connection method between the coupling portion 51 and the cover portion 40 will not be limited. For example, the coupling portion 51 may be disposed in the first through hole 41 of the cover portion 40 by means of riveting, or may be disposed in the first through hole 41 of the cover portion 40 by means of welding, etc.

In some example embodiments, as shown in FIG. 5 and FIG. 6, the coupling portion 51 further has an extruding portion 513. The extruding portion 513 is located between the small diameter portion 511 and the large diameter portion 512 in the axial direction. When the coupling portion 51 is riveted to the first through hole 41 of the cover portion 40, the cover portion 40 is deformed by being pressed by the extruding portion 513, so that the coupling portion 51 and the cover portion 40 are riveted integrally. In addition, after the coupling portion 51 is riveted to the cover portion 40, the extruding portion 513 can also prevent the coupling portion 51 from rotating relative to the cover portion 40.

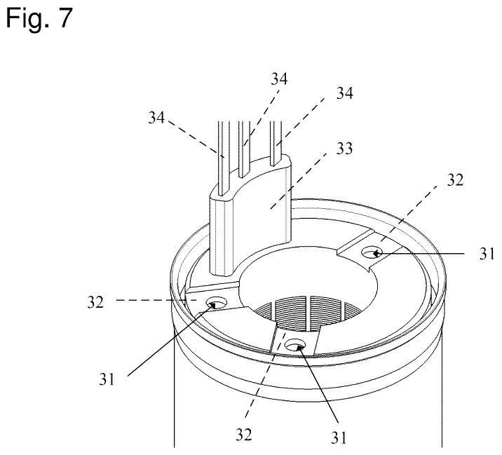

FIG. 7 is a schematic diagram of part of the motor from which the cover portion is removed according to an example embodiment of the present application, where the busbar assembly 30 is shown.

In some example embodiments, as shown in FIG. 7, the upper surface of the busbar assembly 30 is also provided with a recessed portion 32, and the groove 31 is located in the recessed portion 32. That is, in the axial direction, a lower surface of the groove 31 is located below a lower surface of the recessed portion 32, that is, a height of the lower surface of the groove 31 is lower than a height of the lower surface of the recessed portion 32. The large diameter portion 512 of the coupling portion 51 is at least partially accommodated in the recessed portion 32. Therefore, the axial dimension of the motor can be further reduced.

In the above example embodiments, the cross-section of the recessed portion 32 may be in a shape of a radially extending rectangle as shown in FIG. 7, or a circle or a polygon, as long as the inscribed circle is larger than the outer diameter of the large diameter portion 512, so that the large diameter portion 512 can be located in the recessed portion 32, which will not be limited in the present application.

In some example embodiments, the diameter of the inscribed circle of the groove 31 is greater than or equal to the inner diameter of the coupling portion 51 (i.e., the outer diameter of the second through hole 514). Therefore, when the external device is connected to the motor 100 by a bolt, an accommodating space can be provided for the bolt used to connect the external device.

In some example embodiments, as shown in FIG. 2, the busbar assembly 30 includes a resin busbar holder 33 and a busbar 34 partially held in the busbar holder 33. The busbar 34 is staggered from the groove 31 in the axial direction, that is, the busbar 34 is not axially below the groove 31. Therefore, the bolt for connecting the external device can be prevented from coming too close to the busbar and interfering with the busbar.

The motor of this example embodiment of the present application has been described above through different example embodiments from different perspectives. The above example embodiments may be combined in any form, which will be omitted here. In addition, the above content is only an exemplary description of the present application, but the present application is not limited thereto, and appropriate variations can also be made on the basis of the above implementations.

In this example embodiment of the present application, this motor is mounted on an automobile, for example, and is used in a braking system. In addition, this motor may also be used for purposes other than braking. For example, this motor may also be used as a driving source for other parts of the automobile, such as an engine cooling fan or an oil pump. In addition, this motor may also be mounted on home appliances, office automation equipment, medical equipment, etc. to generate various driving forces.

According to the example embodiments of the present application, by forming the through hole in the cover portion of the motor and the groove axially opposite to the through hole in the upper surface of the busbar assembly, the motor is connected to the external device through the groove and the through hole, so a part of the external device is accommodated in the busbar assembly, thereby reducing the axial dimension of the motor and miniaturizing the motor.

This example embodiment of the present application provides an electrical product. The electrical product includes the motor described in the example embodiment of the first aspect. Since the structure of the motor has been described in detail in the example embodiment of the first aspect, its content is incorporated here, which will be omitted here.

In this example embodiment of the present application, the electrical product may be any device or equipment using a motor, including various household equipment, office automation equipment, industrial equipment, vehicle-mounted devices or components in various equipment, etc., such as a brake component using a motor.

It is worth noting that the above content is only an exemplary description of the present application, but the present application is not limited thereto, and appropriate variations may also be made on the basis of the above implementations. In addition, the above is only an illustrative description of various components, but the present application is not limited to this. The specific content of various components may also refer to the related technologies. In addition, components that are not shown in the drawings may be added, or one or more components in the drawings may be reduced.

Example embodiments of the present application are described above in conjunction with specific implementations, but those skilled in the art should be clear that these descriptions are exemplary and are not intended to limit the scope of the present application. Those skilled in the art may make various variations and modifications to the present application according to the principles of the present application, and these variations and modifications are also within the scope of the present application.

The example embodiments and implementations of the present application are described above with reference to the accompanying drawings. Many features and advantages of these example embodiments and implementations are clear according to the detailed description. Therefore, the accompanying claims are intended to cover all these features and advantages that fall within the true spirit and scope of these example embodiments and implementations. Furthermore, since those skilled in the art is prone to think of many modifications and changes, it is not intended to limit the example embodiments and implementations of the present application to the precise structure and operations shown and described, but to cover all suitable modifications and equivalents that fall within its scope.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor, the motor comprising:
a main body portion, including a rotor and a stator;
a case, which is in an axially extending cylindrical shape, includes a bottom and an opening, and accommodates the main body portion;
a busbar assembly, which is located on an axially upper side of the main body portion; and
a cover portion, which is located on an axially upper side of the busbar assembly and covers the opening of the case; wherein
an upper surface of the busbar assembly is provided with a groove;
a first through hole opposite to the groove in an axial direction is defined in the cover portion; and
the motor is connected to an external device through the groove and the first through hole.

2. The motor according to claim 1, wherein an internal thread to provide threaded connection with the external device is provided in an inner surface of the first through hole.

3. The motor according to claim 1, wherein
a coupling portion is located in the first through hole; and
the motor is connected to the external device through the groove, the first through hole and the coupling portion.

4. The motor according to claim 3, wherein
the coupling portion includes a small diameter portion and a large diameter portion;
the small diameter portion passes out of the first through hole and is located on an axially upper side of the cover portion; and
the large diameter portion is located on an axially lower side of the cover portion.

5. The motor according to claim 3, wherein
the coupling portion is provided with a second through hole that penetrates in the axial direction and is axially opposite to the groove; and
an internal thread to provide threaded connection with the external device is defined in an inner surface of the second through hole.

6. The motor according to claim 3, wherein the upper surface of the busbar assembly further includes a recessed portion, the groove is located in the recessed portion, and the large diameter portion of the coupling portion is at least partially located in the recessed portion.

7. The motor according to claim 5, wherein a diameter of an inscribed circle of the groove is greater than or equal to an inner diameter of the coupling portion.

8. The motor according to claim 1, wherein
the busbar assembly includes a busbar holder and a busbar embedded in the busbar holder; and
the busbar is staggered from the groove in the axial direction.

9. An electrical product comprising the motor according to claim 1.
